(19) United States
(12) Patent Application Publication
(10) Pub. No.: US 2022/0154740 A1
(43) Pub. Date: May 19, 2022

(54) IMPROVED HYDRAULIC CYLINDER FOR A WORK VEHICLE

(71) Applicant: CNH Industrial America LLC, New Holland, PA (US)

(72) Inventor: Francesco Chioccola, Settimo Torinese (IT)

(73) Assignee: CNH Industrial America LLC, New Holland, PA (US)

(21) Appl. No.: 17/427,853

(22) PCT Filed: Feb. 3, 2020
(86) PCT No.: PCT/EP2020/052546

§ 371 Date: Aug. 2, 2021

(30) Foreign Application Priority Data
Feb. 1, 2019 (IT) 102019000001511

(51) Int. Cl. F15B 15/20; E02F 9/22

(52) U.S. Cl. CPC F15B 15/20; E02F 9/2214

(57) ABSTRACT

A hydraulic cylinder for operating a work element of a work vehicle includes—a housing defining an inner volume and a piston slidably movable inside the housing in tight manner so as to divide the volume into two fluidly separated portions. The piston is connected by a rod to the work element. The housing defines two openings respectively connected to the two fluidly separated portions for allowing the passage of a fluid in pressure so as to move accordingly the piston. The hydraulic cylinder also includes a cushioning device configured to dampen the movement of piston inside the volume when it receives a sudden movement coming from the work element through the rod. The hydraulic cylinder also includes stroke variation means configured to vary the positioning of cushioning device inside the volume so as to vary a dampened stroke of piston.

### CROSS REFERENCE TO RELATED APPLICATIONS

This application is a U.S. National Stage filing of International Application Serial No. PCT/EP2020/052546 entitled “IMPROVED HYDRAULIC CYLINDER FOR A WORK VEHICLE,” filed Feb. 3, 2020, which claims priority to Italian Application Serial No. 102019000001511, filed Feb. 1, 2019, each of which is incorporated by reference herein in its entirety for all purposes.

### TECHNICAL FIELD

The present invention concerns a hydraulic cylinder for a vehicle, in particular a hydraulic cylinder for a work vehicle such as an earth moving machine, e.g. an excavator or a dozer.

### BACKGROUND OF THE INVENTION

Work vehicles comprises a plurality of work elements which are actuated hydraulically through the use of hydraulic cylinders. In particular earth moving machine comprises elements such as blades or buckets which are operated thanks to such hydraulic cylinders.

During the operation of the aforementioned work elements, hydraulic cylinders should also compensate effect of the inertia due to the movement of such work elements; such inertia compensative function is usually accomplished by a cushioning element.

Such cushioning element is configured to define a narrowing in which fluid is forced to flow for flowing out from cylinder chamber when the chamber volume is reduced.

Often, such cushioning element is a cushioning ring carried by cylinder's rod and defining a narrowing with housing of the cylinder when the piston carried by the rod reaches a preset position in the housing.

However, it usually happens that user of a work vehicle changes the work element, e.g. a bigger bucket or a different shape (i.e. one with different weight) or that the work element carries something which is very heavy and therefore the inertia effect linked to the movement of the boom is different.

According to the above, the cushioning element is no more adequate to dampen the movement of the piston inside the cylinder and therefore cylinder may be damaged or the control of the work element will be worse.

It is therefore needed to provide a hydraulic cylinder which is suitable for being used with different work elements and, at the same time, which can dampen the effect due to inertia of these latter during their movement and use.

An aim of the present invention is to satisfy the above mentioned needs.

### SUMMARY OF THE INVENTION

The aforementioned aim is reached by hydraulic cylinder as claimed in the appended set of claims.

### BRIEF DESCRIPTION OF DRAWINGS

For a better understanding of the present invention, a preferred embodiment is described in the following, by way of a non-limiting example, with reference to the attached drawings wherein:

FIG. 1 is a hydraulic scheme of a hydraulic cylinder according to an embodiment of the invention;

FIG. 1a is a hydraulic scheme of a hydraulic cylinder according to an alternative embodiment of the invention;

FIG. 2 is a partial enlarged sectional view of a hydraulic cylinder according to the invention with parts removed for sake of clarity;

FIG. 2A is a partial sectional view of a hydraulic cylinder according to the invention with parts removed for sake of clarity;

FIG. 3 is a partial sectional view of the hydraulic cylinder of FIG. 2 in a first operative condition; and

FIG. 4 is a partial sectional view of the hydraulic cylinder of FIG. 2 in a second operative condition.

### DETAILED DESCRIPTION OF THE INVENTION

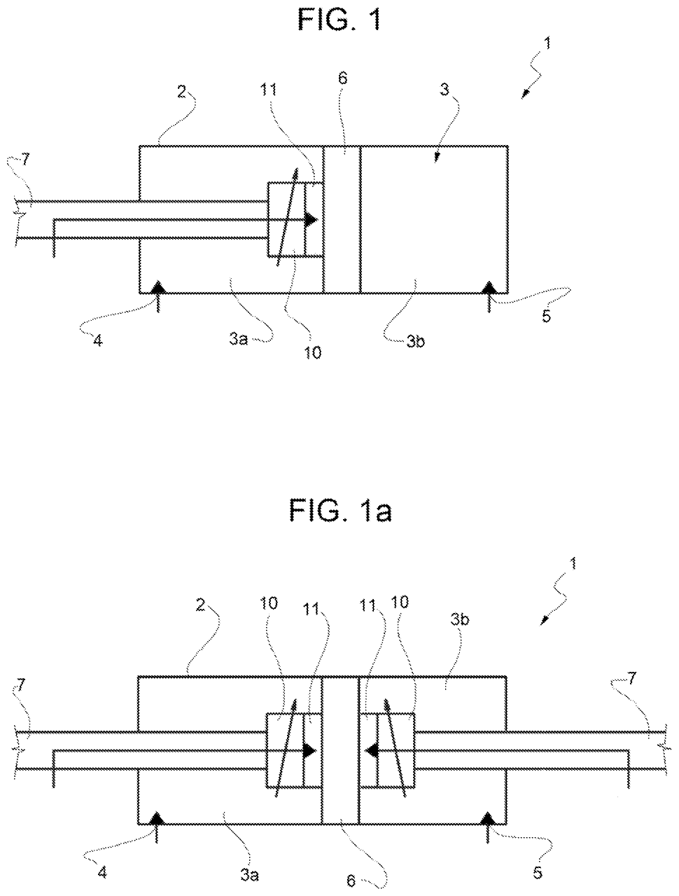

FIG. 1 discloses schematically a hydraulic cylinder 1 for actuating a work element such as a bucket or a blade of a work vehicle. The disclosed cylinder is a differential cylinder, anyway it is clear that the invention may be applied to other typologies of cylinder.

As known in the art, hydraulic cylinder 1 comprises a housing 2 defining a closed inner volume 3 and, according to the chosen typology, a first opening 4 and a second opening 5, these latter are fluidly connected to a source of fluid in pressure, e.g. a pump; fluid pressure may vary in function of the work element which is operated by the cylinder, e.g. about 300 bar.

Hydraulic cylinder further comprises a piston 6 housed into inner volume 3 and configured to slide along a longitudinally axis A of housing 2 in a tight manner with respect to this latter. Therefore, piston 6 divides inner volume 3 into a first portion 3a and a second portion 3b which are of variable longitudinal dimension according to the position of piston 6. Preferably first portion 3a is fluidly connected with first opening 4 and second portion 3b is fluidly connected with second opening 5.

Piston 6 is carried by a rod 7 which passes through housing 2 and cooperates slidably in tight manner with this latter. Piston 6 is connected to the work element which consequently receives the power transmitted hydraulically to fluid entering in, e.g., second portion 3b pushing therefore piston 6 and rod 7 towards the opposite portion 3a.

Hydraulic cylinder further comprises at least a cushioning device 10 configured to dampen the inertia movement of piston 6 inside volume 3.

According to the invention, cylinder 1 comprises stroke variation means 11 configured to vary the stroke of piston 6 inside volume 3 which can be dampened by cushioning device 10, i.e. which can change the relative position of cushioning device 10 with respect to piston 6/rod 7.

In particular, stroke variation means 11 are actuated hydraulically thanks to a dedicated hydraulic line. Preferably such actuation is made by a fluid having a pressure lower than 40 bar, preferably 30-40 bar.

According to FIG. 1a, it is clear that cylinder 1 may comprise two cushioning devices 10, one for each portions 3a, 3b of volume 3 so as to dampen the movement of cylinder 1 in both directions of movement of piston 6 inside volume 3. Accordingly, such cylinder 1 comprise stroke variation means 11 configured to vary the stroke of piston 6 which can be dampened by cushioning devices 10, in both directions of movement of piston 6, i.e. stroke variation means 11 can change the relative position of both cushioning devices 10 with respect to piston 6/rod 7.

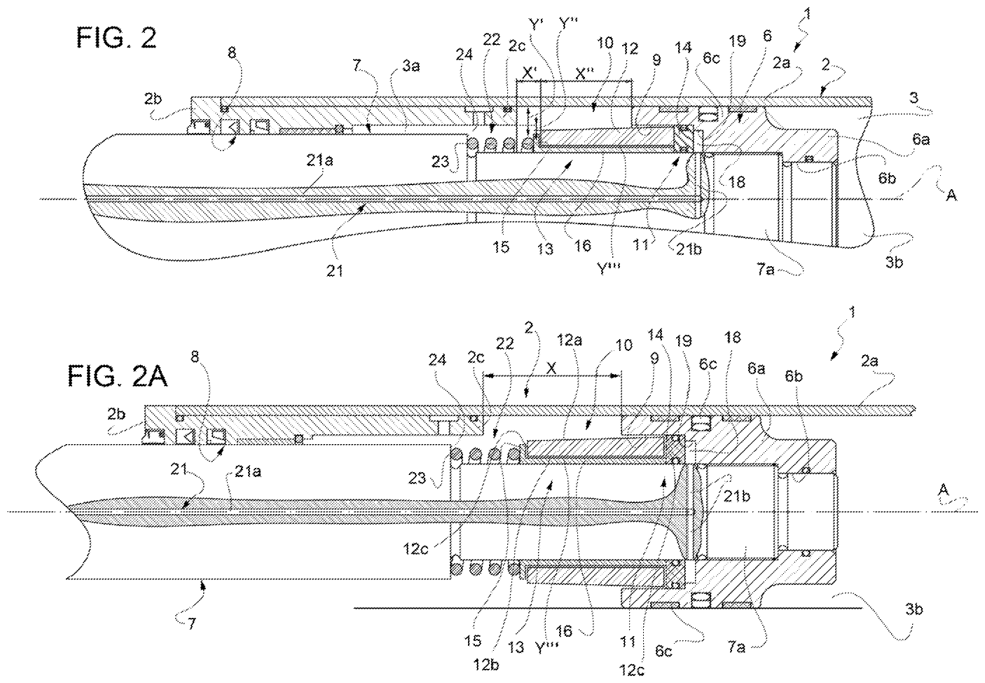

FIG. 2 describes an exemplarily embodiment of a hydraulic cylinder 1 according to the above described principles of the invention.

Cylinder 1 comprises a housing 2 provided with a lateral wall 2a and a pair of axial walls 2b connected together to define a inner volume 3. Preferably axial wall 2b and lateral wall 2a are two different elements connected one to each other in a detachably way to allow the mounting of cylinder 1 itself and, when needed, its inspection. More preferably, lateral wall 2a defines a cylindrical volume 3 axially extending over an axial symmetric axis A.

Cylinder 1 further comprises a piston 6 housed in volume 3 and configured to slide on lateral wall 2a in a tight manner (thanks to known tight means, not disclosed for sake of brevity) thereby fluidly dividing volume 3 into a first portion 3a and a portion volume 3b. As said above, first portion 3a is fluidly connected to a first opening 4 and second portion 3b is fluidly connected to a second opening 4b, both realized on lateral wall 2a of housing 2.

Both portions 3a, 3b are configured to receive, alternatively, a flow of fluid in pressure which pushes piston 6 to slide on housing 2 towards the opposite portion.

Piston 6 is connected to a rod 7 which passes through an opening 8 realized in axial wall 2b of housing 2 in tight way thanks to known tight means, again not disclosed for sake of brevity.

In particular, according to the described configuration, piston 6 comprises a terminal portion 6a having a substantially cylindrical annular shape. Terminal portion 6a defines an opening 6b into which a terminal portion 7a of rod 7 is connected, thereby making piston 6 movable jointly with rod 7.

Piston 6 further comprises a contact portion 6c carried by terminal portion 6a and preferably realized monolithically with this latter. Contact portion 6c extends radially externally from terminal portion 6a and axially parallel to axis A from terminal portion 6a around rod 7 thereby laterally defining an annular chamber 9 with this latter. Annular chamber 9 is therefore an open chamber axially delimited by inner surface of contact portion 6c and outer surface of rod 7 and axially delimited by axial surface of terminal portion 6a and opened on the opposite side.

Radial extension of contact portion 6c is such that an outer surface of this latter slidably cooperates with an inner surface of lateral wall 2b of housing 2. Accordingly, contact portion 6c comprises the already mentioned tight means to allow the slidably thigh movement of piston 6 between portions 3a, 3b of volume 3.

Axial extension of contact portion 6c is such that it is defined a possible stroke X of piston 6 inside volume 3 before axially cooperating at contact with a terminal portion 2c carried by housing 2. In the described embodiment terminal portion 2c is carried by axial wall 2b which is realized as a “cap” inserting inside portion 3a of housing 2. Contact between terminal portion 2c and contact portion 6c therefore defines a mechanical end stop for piston 6.

According to the invention, hydraulic cylinder 1 comprises a cushioning device 10 configured to dampen inertia movement of piston 6/rod 7 inside volume 3 and stroke variation means 11 configured to vary the positioning of cushioning device 10 with respect piston 6/rod 7 in order to vary the dampened stroke of piston 6/rod 7 inside volume 3.

Cushioning device 10 essentially comprises a cushioning ring 12, such cushioning ring 12 is a substantially cylindrically annular ring coaxial to axis A defining an inner surface 12b, an outer surface 12a and a pair of radial surfaces 12c. Outer surface 12a may be inclined with respect to axis A while inner surface 12a is substantially parallel to axis A. Moreover, cushioning ring 12 may comprise grooves (not shown) configured to provide variable passage for fluid flowing along outer surface 12b.

As can be seen in FIGS. 2, 2a stroke X can be divided into a first part X′ wherein there is a first gap Y′ between lateral wall 2b of housing 2 and rod 7 and, when piston 6 moves with respect to housing 2, a second part X″ wherein there is a second gap Y″ which is lower than first gap Y′.

In first part X′ fluid is forced to pass through a annular area having a lateral dimension substantially equal to longitudinal extension of X′, while in second part X″ fluid is forced to pass through a annular area having a lateral dimension substantially equal to second gap Y″ which is significantly lower than longitudinal extension of X″. Such reduce passage gap Y″ generates a dampening effect to piston 6 because fluid generate a resistance due to the narrower passage to reach opening 4.

Moreover, since outer surface 12a is inclined, gap Y″ is advantageously variable becoming smaller and smaller as piston 6 moves closer and closer to terminal portion 2c of housing 2, as is clearly shown in FIG. 4. Accordingly, damping value provided to piston 6 becomes higher and higher proportionally to movement of piston 6 towards terminal surface 2c.

Cushioning ring 12 is advantageously carried by a bushing 13 carried by rod 7. In particular bushing 13 is cylindrical and it is carried by rod 7, preferably by a gap coupling realized between its inner surface and an outer surface of rod 7.

According to the disclosed embodiment, bushing 13 comprises has a substantial U-shaped transversal section comprising a first extremity portion 14, a second extremity portion 15 and an intermediate portion 16 connecting first and second extremity portions 14, 15. In particular, first extremity portion 14 is realized as a different piece with respect to second extremity portion 15 and intermediate portion 16 which are realized monolithically.

Always according to the described embodiment, cushioning ring 12 cooperates at contact with first extremity portion 14 cantilevered with respect to intermediate portion 15 and extending towards second extremity portion 15 without being in contact with this latter. According to such configuration, between cushioning ring 12 and bushing 13 it is realized a thin annular gap Y′″ being L-shaped around lower surface 12b and axial surface 12c facing to second extremity portion 15 of bushing 13. Thin annular gap Y′″ is configured to make bushing 13 floating and therefore to allow its self-centering on rod 7 because of the passage of fluid into such thin annular gap Y′″.

According to the disclosed configuration, stroke variation means 11 are configured to move bushing 13 and, consequently cushioning ring 12, on outer surface of rod 7 so as to vary the length of second part X″, i.e. to vary the value of the stroke of piston 6 at which the damping is generated.

Indeed, bushing 13 carried by rod 7 with possibility of linear movement along axis A if a preset force is applied; stroke variation means 11 are therefore configured to impart a force to bushing 13 proportional to the desired length of second portion X″.

According to the disclosed configuration, stroke variation means 11 hydraulically imparts a force to bushing 13, in particular as described below.

First extremity portion 14 of bushing 13 is housed inside annular chamber 9 so as to be radially in contact with both the outer surface of rod 7 and inner surface of contact portion 6c. Such contact is slidably, as said, and is realized in tight manner thanks to known tight means, not further described for sake of clarity.

In a condition in which second portion X″ is at its minimum value, i.e. into which first extremity portion 14 of bushing 13 is in its innermost position inside chamber 9, a radial annular chamber 18 is realized between piston 6, rod 7 and first extremity portion 14 of bushing 13. In particular, axial surface of terminal portion 6a facing into annular chamber 9 has a radial distance with respect to rod 7 which is lower than the radial distance of inner surface of contact portion 6c, thereby defining an indentation 19 which cooperate at contact with first extremity portion 14 of bushing 13 thereby defining chamber 18 which is axially delimited by first extremity portion 14 and terminal portion 6a of piston 6 and radially delimited by indentation 19 and outer surface of rod 7. Chamber 18 has therefore an axially variable diameter volume according to the movement of bushing 13 along rod 7 and is fluidly isolated with respect to first portion 3a of volume 3.

Radial annular chamber 19 is fluidly connected to a source of fluid in pressure (not shown) configured to supply chamber with such fluid in pressure so as to generate a distributed force on first extremity portion 14 and move consequently bushing 13. Fluid in pressure may reach a pressure of about 30-40 bar.

Pressure source is fluidly connected to annular chamber 19 thanks to a conduit 21 which may be realized into rod 7, in particular comprising a first portion 21a coaxial to axis A and a plurality of terminal branches 21b configured to provide fluid into chamber 19 from different introduction points.

Hydraulic cylinder further comprises preload means 22 configured to maintain cushioning ring in a preset position into which second portion stroke X″ is at its minimum preset value. Further preload means 22 are configured to define a maximum displacement of bushing 13 with respect to rod 7 thereby defining a maximum value of second portion stroke X″.

According to the described configuration, preload means 22 comprises elastic means 23 configured to impart a load to second extremity portion 14 of bushing 13. In particular, elastic means 23 comprises a coil spring which is mechanically interposed between rod 7 and bushing 13.

According to the described example rod 7 defines a shoulder 24 radially extending over outer surface into which bushing 13 slides defining a support point for elastic means 23. Accordingly coil spring is wound coaxial to axis A around outer surface of rod 7 and has a first extremity portion cooperating with shoulder 24 and a second extremity portion cooperating with second extremity portion 15 of bushing 13.

The operation of the above described hydraulic cylinder 1 according to the invention is the following.

In a normal operating condition, fluid may enter by either opening 4 or opening 5 thereby pushing piston 6 on the opposite side with respect to the one into which fluid enters in volume portions 3a, 3b. The movement of piston 6 is then transmitted to rod 7 which is fixedly carried to this latter and thereby to the work element associated to rod 7.

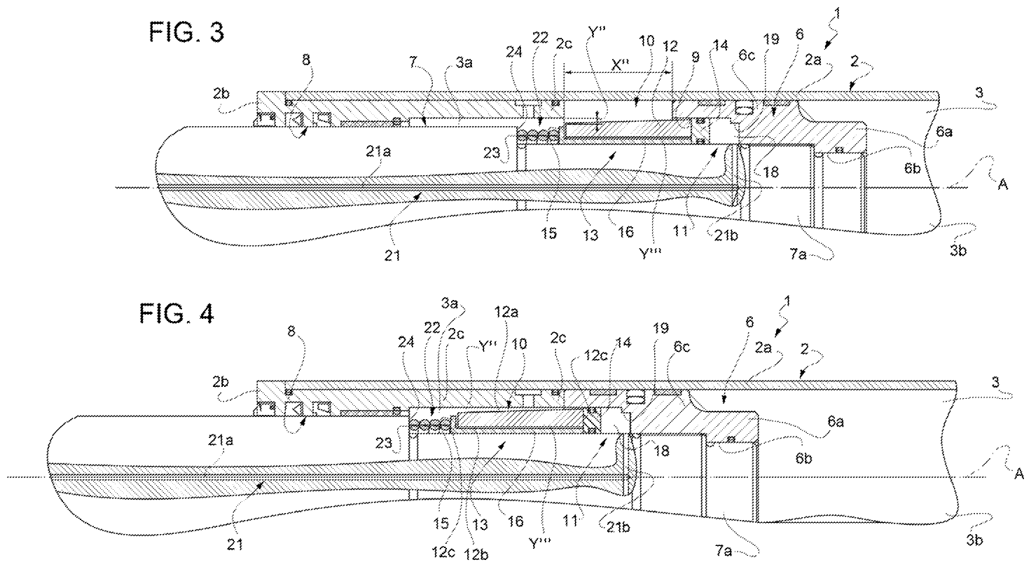

According to FIG. 3, fluid is entering from opening 5 in portion 3b of volume 3 thereby pushing piston 6 towards left axial wall 2b of housing 2 so as to reach, for example, the final position of FIG. 4 into which contact portion 6c of piston 6 is in contact with terminal portion 2c of housing 2.

However, as said, inertia due to mass of work element will drag piston 6. Consequently, fluid will flow away from opening passing before through greater opening in first stroke portion X′ and, then, through a closer opening of the dimension of gap Y″ in second stroke portion X″ generating therefore a dampening to motion of piston 6 due to lower space for fluid to flow out.

If the user changes the work element of if the work element transports something very heavy, the user may activate, e.g. by a button or a command on a display, the change of the length dampened stroke of piston 6.

Moreover, since cushioning ring outer surface 12a is inclined, the dampening will be higher and higher according to the greater displacement of cushioning ring 12.

In the meanwhile, preload means maintain a preset minimum level of dampened stroke X″ thanks to the preload imparted to bushing 13 via elastic means 23. Further, the presence of the preload allows a precise control of position of cushioning device thanks to the equilibrium of the force imparted by these latter and the force given by the pressure of fluid in chamber 18.

In view of the foregoing, the advantages of a hydraulic cylinder 1 according to the invention are apparent.

Thanks to the proposed cushioning device 10 together with the associated stroke variation means 11, it is possible to vary the length of the dampened stroke of piston 6, thereby adapting the cylinder to the new work element/load to be carried.

Since the control of such stroke is made hydraulically, it is possible to accurate regulate this latter according to user's necessity electrically or manually in a fast and optimized way.

The use of a cushioning ring 12 spaced with respect to its support, i.e. bushing 13, and having an inclined surface 12a allows to obtain a controlled greater and variable value of damping along the stroke of piston 6.

Preload means allows to control at the same time both the maintenance of a preset, minimum, value of dampened stroke and to maintain such stroke below a maximum value when said preload means are locked/packed.

It is clear that modifications can be made to the described hydraulic cylinder 1 which do not extend beyond the scope of protection defined by the claims.

For example, as said, the proposed cushioning device may be used for any typology of cylinder. Further, it is clear that a cylinder may comprise more than a single cushioning device which can be realized in many ways and not limited to a cushioning ring as described.

Similarly, actuation of stroke variation means 11 may be realized electrically, pneumatically or mechanically and preload means or similarly bushing 13 may comprise functional equivalent elements. The same obviously applies to the proposed shape of rod 7 and piston 6 or housing 2.

Further, a cylinder 1 with two cushioning devices 10, as depicted in FIG. 1a, may comprise a single rod 7 and common channels for actuating both cushioning devices 10 may be realized in rod 7 and piston 6.

1-15. (canceled)

16. A hydraulic cylinder for operating a work element of a work vehicle, the hydraulic cylinder comprising:
a housing defining an inner volume and a piston slidably movable inside the housing in tight manner so as to divide the volume into two fluidly separated portions, the piston being connected by a rod to the work element, the housing defining two openings respectively connected to the two fluidly separated portions for allowing an alternatively passage of a fluid in pressure so as to move accordingly the piston inside a longitudinal axis of the hydraulic cylinder;
a cushioning device configured to dampen the movements of the piston inside the volume; and
stroke variation means configured to vary the positioning of the cushioning device inside the volume so as to vary a dampened stroke of the piston.

17. The hydraulic cylinder according to claim 16, wherein the cushioning device and the stroke variation means are carried by one of the rod and the piston.

18. The hydraulic cylinder according to claim 16, wherein the stroke variation means vary the position of the cushioning device based on a hydraulic pressure exerted on the cushioning device.

19. The hydraulic cylinder according to claim 16, wherein the cushioning device defines a first gap with the housing which is narrower than a second gap defined by the rod and the housing, the passage of fluid in the narrower second gap defining the dampening to the piston.

20. The hydraulic cylinder according to claim 19, wherein the cushioning device comprises a cushioning ring carried by a bushing which is carried by the rod, the stroke variation means moving the bushing with respect to the rod.

21. The hydraulic cylinder according to claim 20, wherein the cushioning ring comprises an outer surface and an inner surface, the inner surface being parallel to the longitudinal axis.

22. The hydraulic cylinder according to claim 21, wherein the outer surface is inclined with respect to the inner surface so as to vary the value of a damping value according to the stroke of the piston inside the housing.

23. The hydraulic cylinder according to claim 20, wherein the bushing has a substantial U-shaped cross-section and comprises a first extremity portion a second extremity portion and an intermediate portion connecting together the first and second extremity portions, the cushioning ring being carried by one of the first and second extremity portions in a cantilevered way and spaced with respect to the other of the first and second extremity portions so as to define a annular gap.

24. The hydraulic cylinder according to any of claim 23, wherein the first extremity portion is configured to slide with the piston and the rod thereby defining with the piston and the rod a variable volume chamber, the variable volume chamber being fluidly connected to a source of fluid in pressure configured to provide fluid into the variable volume chamber so as to exert a pressure against the bushing and move accordingly the cushioning ring.

25. The hydraulic cylinder according to claim 24, wherein the source of fluid is pressurized at about 30-40 bar.

26. The hydraulic cylinder according to claim 24, wherein the variable volume chamber is fluidly connected to the source of fluid via a conduit realized into the rod.

27. The hydraulic cylinder according to any of claim 16, further comprising a preload means configured to maintain the cushioning device into a position in which the dampened stroke is at a minimum preset value.

28. The hydraulic cylinder according to claim 27, wherein the preload means are further configured to limit the movement of the bushing with respect to the rod to a maximum preset value.

29. The hydraulic cylinder according to claim 27, wherein the preload means comprises an elastic means interposed with respect to the bushing and the rod.

30. The hydraulic cylinder according to any of the preceding claims, wherein the cushioning device comprises a first cushioning device in a first portion of the two fluidly separated portions for dampening the movement of the piston in a first direction, and a second cushioning device in a second portion of the two fluidly separated portions for dampening the movement of the piston in an opposite direction.

31. A work vehicle comprising a work element connected to a rod of a hydraulic cylinder according to claim 1.
